(19) United States
(12) Patent Application Publication
(10) Pub. No.: US 2010/0241326 A1
(43) Pub. Date: Sep. 23, 2010

(54) Control apparatus for automatic transmission

(75) Inventors: Yasunari Muranaka, Okazaki (JP); Yasuhiko Kobayashi, Anjo (JP); Shinichiro Iga, Anjo (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-Shi (JP)

(21) Appl. No.: 12/656,359

(22) Filed: Jan. 27, 2010

(30) Foreign Application Priority Data
Mar. 17, 2009 (JP) 2009-064808

(51) Int. Cl. G06F 19/00

(52) U.S. Cl. 701/58

(57) ABSTRACT

A control apparatus for an automatic transmission, the control apparatus includes a main pump that is rotation driven by an engine and supplies hydraulic oil via an oil passage of a vehicle automatic transmission; an auxiliary pump that is rotation driven by an electric motor and supplies hydraulic oil to the oil passage to assist the main pump; a regulator valve that regulates a line pressure of the oil passage to a predetermined value; a regulator valve control section that sends a command to regulate the line pressure to the regulator valve; a line pressure obtaining section that obtains the line pressure of the oil passage; and an auxiliary pump start section that controls starting of the auxiliary pump.

### CROSS-REFERENCE TO RELATED APPLICATION

The disclosure of Japanese Patent Application No. 2009-064808 filed on Mar. 17, 2009 including the specification, drawings and abstract is incorporated herein by reference in its entirety.

### BACKGROUND

The present invention relates to a control apparatus for controlling oil pressure supply to an automatic transmission by using a main pump driven by a vehicle engine and an auxiliary pump driven by an electric motor.

An “idle stop” control, which is a control for automatically stopping an engine only during a period after a vehicle is stopped at intersections or the like until the vehicle is started, has attracted attention for ecological reasons. In a vehicle provided with a commonly used automatic transmission, a hydraulic pump for supplying a hydraulic oil pressure in the automatic transmission for completing a shift speed is structured to be driven by an engine. Thus, if the engine of a vehicle using such an idle stop control is automatically stopped, the oil pressure in a transmission hydraulic circuit is reduced, and the automatic transmission is shifted to a neutral state. If the engine is automatically restarted in this state, the oil pressure in the transmission hydraulic circuit increases, and the automatic transmission restores to the state right before the engine is stopped. At this time, a shock occurs if the engine speed is high.

A technique of supplying an oil pressure to a transmission hydraulic circuit by an auxiliary hydraulic pump, which is driven by an electric motor, while the engine is stopped has been proposed in order to prevent this problem (see, e.g., Japanese Patent Application Publication No. JP-A-2002-310272 (Paragraphs [0001] to [0008], FIG. 1)). In the structure in which the hydraulic oil pressure of the transmission hydraulic circuit acts on the discharge side of the auxiliary hydraulic pump as a back pressure, the oil pressure may not immediately decrease even when the engine is automatically stopped. In this case, a high back pressure may act on the auxiliary hydraulic pump. In such a situation, if an electric motor for the auxiliary hydraulic pump, especially an electric motor such as a sensorless brushless direct current (DC) motor, is started in response to the automatic stop of the engine, load torque, which is large enough to overcome the back pressure of the auxiliary hydraulic pump, may not be able to be generated, resulting in unstable starting of the motor and damages to the motor itself. In order to solve such problems, an oil pressure supply apparatus of Japanese Patent Application Publication No. JP-A-2002-310272 (Paragraphs [0001] to [0008], FIG. 1) includes: a main hydraulic pump that is driven by a vehicle engine and supplies a hydraulic oil pressure of a first level to the hydraulic circuit of the automatic transmission; and an auxiliary hydraulic pump that is driven by an electric motor in a period during which the engine is stopped and supplies an oil pressure of a second level that is lower than the first level. A check valve for preventing transmission of an oil pressure toward the auxiliary hydraulic pump is provided in a discharge-side oil passage of the auxiliary pump, and a relief valve, which is opened with an oil pressure of a third level that is lower than the first level and higher than the second level, is connected between the check valve in the discharge-side oil passage of the auxiliary pump and the auxiliary hydraulic pump.

### SUMMARY

According to the oil pressure supply apparatus of Japanese Patent Application Publication No. JP-A-2002-310272 (Paragraphs [0001] to [0008], FIG. 1), the back pressure, which acts on the discharge side of the auxiliary hydraulic pump, can be limited to a predetermined value or less by the check valve provided in the discharge-side passage of the auxiliary hydraulic pump, and the relief valve connected between the check valve and the auxiliary hydraulic pump. However, this structure causes a problem in terms of the cost resulting from adding the relief valve, and a problem in terms of the space regarding arrangement of the relief valve.

It is an object of the present invention to provide a technique capable of eliminating, without requiring a relief valve, adverse effects of a back pressure on an electric motor in a hydraulic circuit of an automatic transmission that includes an electric motor-driven hydraulic pump for assisting an engine-driven main hydraulic pump in order to implement an idle stop control and the like.

In order to achieve the above object, a control apparatus for an automatic transmission according to a first aspect of the present invention includes: a main pump that is rotation driven by an engine and supplies hydraulic oil via an oil passage of a vehicle automatic transmission; an auxiliary pump that is rotation driven by an electric motor and supplies hydraulic oil to the oil passage to assist the main pump; a regulator valve that regulates a line pressure of the oil passage to a predetermined value; a regulator valve control section that sends a command to regulate the line pressure to the regulator valve; a line pressure obtaining section that obtains the line pressure of the oil passage; and an auxiliary pump start section that controls starting of the auxiliary pump. In the control apparatus, the auxiliary pump start section requests the regulator valve control section to output a command to reduce the line pressure, when the line pressure at the time of starting the auxiliary pump is higher than a guaranteed withstand pressure of the auxiliary pump, and the auxiliary pump start section starts the auxiliary pump in a state where the line pressure is equal to or lower than the guaranteed withstand pressure.

According to this structure, when the line pressure is higher than the guaranteed withstand pressure of the auxiliary pump, the auxiliary pump start section requests the regulator valve control section to output a command to reduce the line pressure. Thus, even though no relief valve is provided, the auxiliary pump is started in the state where the requested line pressure is equal to or lower than the guaranteed withstand pressure of the auxiliary pump. Thus, the adverse effects of the back pressure on the electric motor can be eliminated without requiring a relief valve, thereby preventing the problems in terms of the cost and space resulting from adding the relief valve.

The line pressure of the oil passage can be detected by various methods. However, the use of a structure in which the line pressure is calculated based on the command to regulate the line pressure, which is a control signal from the regulator valve control section to the regulator valve, is advantageous in terms of the cost, because no special pressure detection sensor need be provided in the oil passage or the like. Note that, even if the regulator valve control section outputs a command to regulate the line pressure to a value equal to or lower than the guaranteed withstand pressure of the auxiliary pump, the engine speed may not be reduced as expected for some reason, and an actual line pressure may become equal to or higher than the guaranteed withstand pressure of the auxiliary pump. In view of such special cases, a condition that the engine speed has reached a predetermined value, which corresponds to reduction of the line pressure to the guaranteed withstand pressure by the main pump, may be additionally provided as a condition to start the auxiliary pump by the auxiliary pump start section.

It should be understood that, in order to improve the starting stability of the auxiliary pump by detecting an actual line pressure of a desired location, a line pressure detector that detects such a line pressure may be provided in the oil passage or the like, so that the line pressure obtaining section calculates the line pressure based on a detection value of the line pressure detector.

Moreover, in one preferred embodiment of the present invention, in response to the request from the auxiliary pump start section to output the command to reduce the line pressure, the regulator valve control section may be structured to output the command to regulate the line pressure to a value that is equal to or higher than the minimum transfer torque of the automatic transmission hydraulic clutch, which is requested when a vehicle is started at the line pressure equal to or lower than the guaranteed withstand pressure of the auxiliary pump. According to this structure, at least the oil pressure that is equal to or higher than the minimum transfer torque of the automatic transmission hydraulic clutch is ensured even if the line pressure is equal to or less than the guaranteed withstand pressure. This eliminates disadvantages such as a failure to normally start the vehicle.

Once started, the auxiliary pump is stopped when the line pressure increases as a result of driving the main pump upon restarting of the engine. If the auxiliary pump is stopped when the main pump has not been sufficiently driven and the line pressure is low, the oil pressure becomes temporarily insufficient. In order to eliminate this problem, in one preferred embodiment of the present invention, a condition that the engine speed has become lower than a predetermined value at which the main pump can supply the line pressure capable of ensuring a minimum transfer torque capacity of the automatic transmission hydraulic clutch, may be provided as a condition to start the auxiliary pump by the auxiliary pump start section. This enables the minimum transfer torque capacity of the automatic transmission hydraulic clutch to be ensured.

After the main pump is driven, if there is a delay in stopping the auxiliary pump, and the line pressure becomes equal to or higher than the guaranteed withstand pressure of the auxiliary pump before the auxiliary pump is stopped, the electric motor of the auxiliary pump has the disadvantages as described above. Thus, the control apparatus may further include an auxiliary pump stop section that controls stopping of the auxiliary pump, and a condition that the line pressure is higher than the guaranteed withstand pressure of the auxiliary pump may be provided as a condition to stop the auxiliary pump by the auxiliary pump stop section.

The degree to which the line pressure is increased by driving the main pump depends on the engine speed. Based on this fact, the control of stopping the auxiliary pump may be performed based on the engine speed. Thus, in another preferred embodiment of the present invention, a condition that the engine speed has reached a predetermined value corresponding to recovery of the line pressure by the main pump may be provided as a condition to stop the auxiliary pump by the auxiliary pump stop section.

Moreover, a line pressure of a low level increases when the regulator valve control section outputs a command to increase the line pressure. Based on this fact, a condition that the regulator valve control section has output a command to increase the line pressure may be provided as a condition to stop the auxiliary pump by the auxiliary pump stop section.

### BRIEF DESCRIPTION OF THE DRAWINGS

FIG. 1 is a schematic diagram illustrating principles of a control apparatus for an automatic transmission according to the present invention;

FIG. 2 is a schematic diagram showing an embodiment of the control apparatus for the automatic transmission according to the present invention;

FIG. 3 is a flowchart showing a basic routine of an auxiliary pump control;

FIG. 4 is a flowchart showing an auxiliary pump start control routine;

FIG. 5 is a flowchart showing an auxiliary pump stop control routine;

FIG. 6 is a timing chart showing the auxiliary pump control; and

FIG. 7 is a timing chart showing an auxiliary pump control in another embodiment.

### DETAILED DESCRIPTION OF EMBODIMENTS

An embodiment of the present invention will be described with reference to the accompanying drawings.

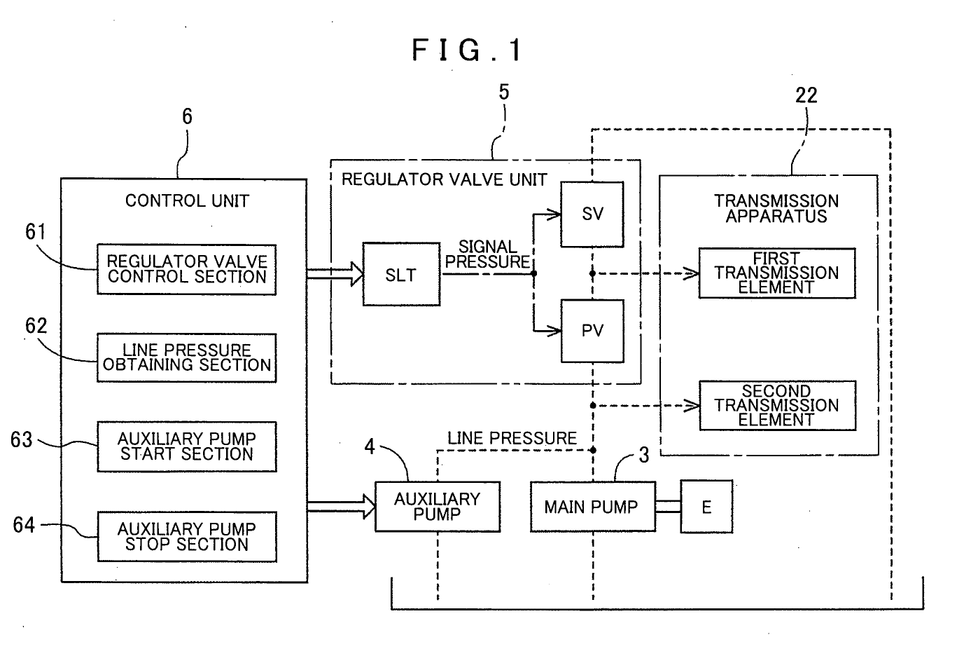

First, principles of a control apparatus for an automatic transmission according to the present invention will be described with reference to the schematic diagram of FIG. 1. A hydraulic circuit shown in FIG. 1 is a hydraulic circuit for supplying hydraulic oil to a vehicle automatic transmission. A main pump 3 that is rotation driven by an engine E, and an auxiliary pump 4 that is rotation driven by an electric motor to assist the main pump 3 are provided as an oil pressure source. A regulator valve unit 5 is also provided to regulate a line pressure of the hydraulic circuit. A control unit 6 outputs control signals, such as a command to regulate the line pressure, which is issued for the regulator valve unit 5, and a command to start/stop the electric motor, which is issued for the electric motor for the auxiliary pump 4. The control unit 6 includes function executing sections, such as a regulator valve control section 61 for sending a command to regulate the line pressure to the regulator valve unit 5, a line pressure obtaining section 62 for obtaining the line pressure of a desired oil passage of the hydraulic circuit, an auxiliary pump start section 63 for controlling starting of the auxiliary pump 4, and an auxiliary pump stop section 64 for controlling stopping of the auxiliary pump 4.

The auxiliary pump start section 63 requests the regulating valve control section 61 to output a command to reduce the line pressure, when the line pressure at the time of starting the auxiliary pump 4 is higher than a guaranteed withstand pressure of the auxiliary pump 4. The auxiliary pump start section 63 starts the auxiliary pump 4 in the state where the line pressure is equal to or lower than the guaranteed withstand pressure. That is, the auxiliary pump 4 is started on the condition that the line pressure is equal to or lower than the guaranteed withstand pressure of the auxiliary pump 4. A condition that the rotational speed of the engine E (the engine speed) has become lower than a predetermined value corresponding to reduction of the line pressure to the guaranteed withstand pressure by the main pump 3 can be added as a condition to start the auxiliary pump 4. The line pressure obtaining section 62 can be structured to calculate the line pressure based on a command to regulate the line pressure, which is output from the regulator valve control section 61. It should be understood that, in the case where the hydraulic circuit is provided with a line pressure detector for detecting the line pressure of a desired location, the line pressure can be calculated based on the detection value of the line pressure detector.

The auxiliary pump stop section 64 stops the auxiliary pump 4 on the condition that the line pressure is higher than the guaranteed withstand pressure of the auxiliary pump 4. In the auxiliary pump stop section 64, a condition that the engine speed has reached a predetermined value corresponding to recovery of the line pressure by the main pump 3, that is, a condition that the line pressure has reached the guaranteed withstand pressure of the auxiliary pump 4, can also be added as the condition to stop the auxiliary pump 4. Moreover, a condition that a command to increase the line pressure has been output from the regulator valve control section 61 can be added as the condition to stop the auxiliary pump.

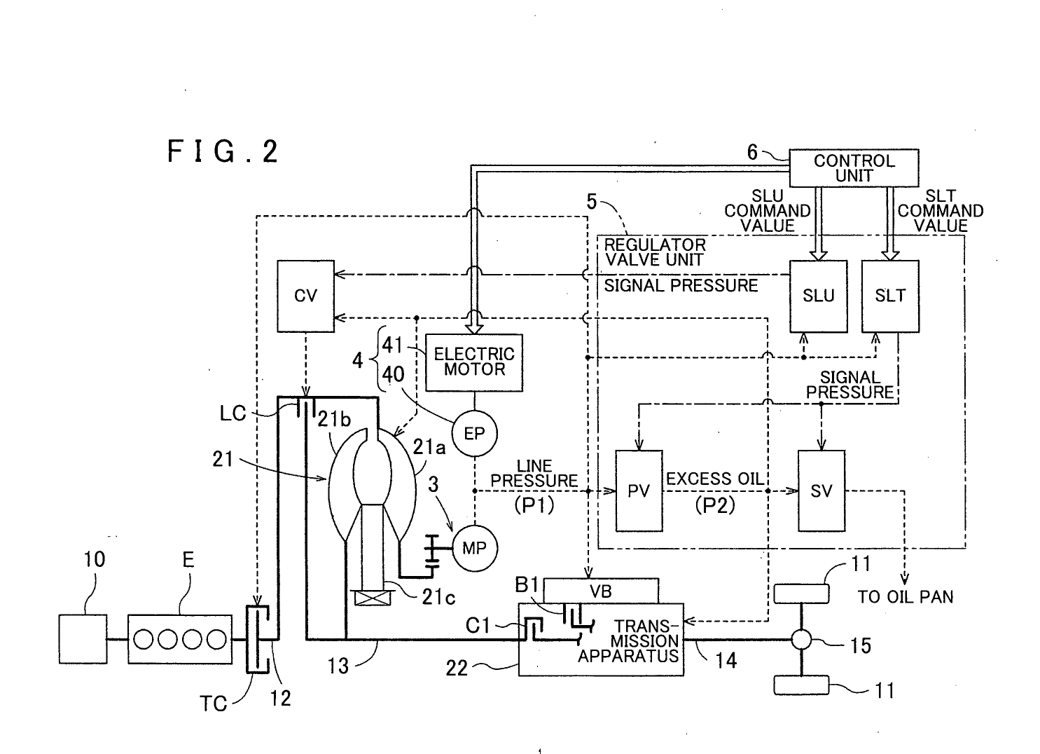

FIG. 2 is a schematic diagram of a drive system in an embodiment in which the control apparatus for the automatic transmission according to the present invention is applied to an automatic transmission vehicle using an idle stop technique. Note that, in FIG. 2, solid lines represent transmission paths for transmitting a driving force, broken lines represent supply oil passages for supplying hydraulic oil, chain lines represent supply paths for supplying a signal pressure, which is the command to regulate the line pressure, and white arrows represent supply paths for supplying a control electric signal. Characters (P1) or (P2), which are shown under the broken lines representing the supply oil passages for supplying the hydraulic oil, mean that the oil pressure of the hydraulic oil in the supply oil passage is a first oil pressure P1 or a second oil pressure P2. As shown in the drawing, the drive system is generally configured to transmit a driving force of the engine E that is started by a starter 10 to wheels 11 via a torque converter 21 and a transmission apparatus 22. Various hydraulic elements provided in the hydraulic circuit are controlled by the control unit 6 so that the hydraulic oil having the first oil pressure P1 or the second oil pressure P2 is basically supplied to the automatic transmission formed by transmission elements such as the torque converter 21 and the transmission apparatus 22.

The transmission apparatus 22 is provided between the engine E and the wheels 11. The transmission apparatus 22 shifts a rotational driving force transmitted from the engine E via the torque converter 21, and transmits the shifted rotational driving force toward the wheels 11. The torque converter 21 is an apparatus that is provided between the engine E and the transmission apparatus 22, and transmits a rotational driving force of an input shaft 12 to the transmission apparatus 22 via an intermediate shaft 13. The torque converter 21 herein includes a pump impeller 21a as an input-side rotation member connected to the input shaft 12, a turbine runner 21b as an output-side rotation member connected to the intermediate shaft 13, and a stator 21c that is provided between the pump impeller 21a and the turbine runner 21b, and includes a one-way clutch. The torque converter 21 transmits a driving force between the drive-side pump impeller 21a and the driven-side turbine runner 21b via hydraulic oil filling the torque converter 21. The torque converter 21 is provided with a lockup clutch LC as a lockup friction engagement element. The lockup clutch LC is a clutch that is connected to integrally rotate the pump impeller 21a and the turbine runner 21b in order to eliminate the rotation difference (slipping) between the pump impeller 21a and the turbine runner 21b, and thus, to increase the transmission efficiency. Thus, when the lockup clutch LC is in an engaged state, the torque converter 21 directly transmits the driving force of the engine E (the input shaft 12) to the transmission apparatus 22 (the intermediate shaft 13) without using the hydraulic oil. The hydraulic oil having the second oil pressure P2 is supplied to the torque converter 21 including the lockup clutch LC.

In the present embodiment, the transmission apparatus 22 is a stepped automatic transmission having a plurality of shift speeds. Thus, in order to form the plurality of shift speeds having different gear ratios from each other, the transmission apparatus 22 includes a gear mechanism such as a planetary gear mechanism (not shown), and a plurality of friction engagement elements such as clutches and brakes, for engaging or disengaging rotation elements of the gear mechanism to switch the shift speed. FIG. 2 shows a first clutch C1 and a first brake B1 as examples of such frictional engagement elements. Note that the transmission apparatus 22 actually includes more friction engagement elements for switching the shift speed, such as clutches and brakes. The transmission apparatus 22 shifts the rotational speed of the intermediate shaft 13 and converts the torque at a predetermined gear ratio determined for each shift speed, and transmits the resultant torque to an output shaft 14. The rotational driving force transmitted from the transmission apparatus 22 to the output shaft 14 is transmitted to the wheels 11 via a differential apparatus 15.

On the other hand, the plurality of friction engagement elements C1, B1 of the transmission apparatus 22 are supplied with hydraulic oil of the first oil pressure P1, and are controlled to operate by a shift control valve unit VB, which is a hydraulic control valve for a shift control. The shift speed is switched among the plurality of shift speeds by engaging or disengaging the plurality of friction engagement elements C1, B1. That is, the transmission apparatus 22 is supplied with the hydraulic oil of the first oil pressure P1 to perform the operation of switching the shift speed. For example, a first shift speed is formed when only the first clutch C1 is engaged, and a second shift speed is formed when the first clutch C1 and the first brake B1 are engaged.

The friction engagement elements included in the automatic transmission are divided into a first group in which a basic oil pressure of hydraulic oil that is supplied thereto is the first oil pressure P1, and a second group in which a basic oil pressure of hydraulic oil that is supplied thereto is the second oil pressure P2. Note that the hydraulic oil of the second oil pressure P2 is supplied to lubricate and cool the parts of the transmission apparatus 22. In the present embodiment, the first clutch C1 of the transmission apparatus 22 belongs to the first group, and the lockup clutch LC of the torque converter 21 belongs to the second group.

The structure of the hydraulic circuit for supplying hydraulic oil to each part of the above automatic transmission will be described below. This hydraulic circuit includes two kinds of pumps as an oil pressure source for pumping up hydraulic oil accumulated in an oil pan, and supplying the hydraulic oil to each part of the automatic transmission: a mechanical pump 3 as a main pump; and an electric pump 4 as an auxiliary pump. The mechanical pump 3 is an oil pump that operates by a rotational driving force of the input shaft 12 (the engine E). For example, a gear pump, a vane pump, or the like is preferably used as the mechanical pump 3. In this example, the mechanical pump 3 is connected to the input shaft 12 via the pump impeller 21a of the torque converter 21, and is driven by the rotational driving force of the engine E. The mechanical pump 3 basically has discharge capacity that is sufficiently greater than the amount of hydraulic oil required for the automatic transmission. However, the mechanical pump 3 discharges no hydraulic oil while the engine E is stopped. Moreover, the mechanical pump 3 discharges the hydraulic oil while the input shaft 12 is rotating at a low speed (that is, while the vehicle is running at a low speed), but may not be able to supply the amount of hydraulic oil required for the automatic transmission. Thus, this automatic transmission includes the electric pump 4 to assist the mechanical pump 3.

The electric pump 4 is an oil pump that is operated by a driving force of the electric motor 41 for driving the pump, regardless of the driving force of the engine E. A gear pump, a vane pump, or the like is also preferably used as, e.g., a pump main body 40 of the electric pump 4. The electric motor 41 for driving the electric pump 4 is electrically connected to an accumulator battery apparatus, not shown, and is supplied with the electric power from the accumulator battery apparatus to generate a driving force. This electric pump 4 is a pump that assists the mechanical pump 3, and operates in the state where a required amount of hydraulic oil is not supplied from the mechanical pump 3, such as when the vehicle is stopped or is running at a low speed as described above. In view of such properties as an auxiliary pump, and in order to reduce the size and weight, and to reduce the power consumption of the electric motor 41, a pump having less discharge capacity than that of the mechanical pump 3 is used as the electric pump 4.

A hydraulic control system includes a primary regulator valve PV and a secondary regulator valve SV as regulator valves for regulating the oil pressure of the hydraulic oil that is supplied from the mechanical pump 3 and the electric pump 4 to a predetermined value. The primary regulator valve PV is a regulator valve for regulating the oil pressure of the hydraulic oil supplied from the mechanical pump 3 and the electric pump 4 to the first oil pressure P1. The secondary regulator valve SV is a regulator valve for regulating the oil pressure of excess oil from the primary regulator valve PV to the second oil pressure P2. Thus, the second oil pressure P2 is set to a value lower than the first oil pressure P1. The first oil pressure P1 corresponds to a line pressure, which is a reference oil pressure of the automatic transmission, and the value of the line pressure is determined based on a signal pressure that is supplied from a linear solenoid valve SLT based on a control command from the control unit 6.

A signal pressure from the common linear solenoid valve SLT for regulating the oil pressure is supplied to the primary regulator valve PV and the secondary regulator valve SV. The primary regulator valve PV regulates the oil pressure of hydraulic oil on the upstream side (on the mechanical pump 3 and the electric pump 4 side) of the primary regulator valve PV, which is supplied from the mechanical pump 3 and the electric pump 4, to the first oil pressure P1 according to the supplied signal pressure. In this example, the primary regulator valve PV regulates the amount by which the hydraulic oil supplied from the mechanical pump 3 and the electric pump 4 is discharged toward the secondary regulator valve SV, based on the balance between the signal pressure supplied from the linear solenoid valve SLT and a feedback pressure of the first oil pressure P1 regulated by the primary regulator valve PV. That is, when a large amount of hydraulic oil is supplied from the mechanical pump 3 and the electric pump 4, the primary regulator valve PV increases the amount of hydraulic oil to be discharged toward the secondary regulator valve SV. On the other hand, when a small amount of hydraulic oil is supplied from the mechanical pump 3 and the electric pump 4, the primary regulator valve PV reduces the amount of hydraulic oil to be discharged toward the secondary regulator valve SV. Thus, the primary regulator valve PV regulates the oil pressure of the hydraulic oil on the upstream side of the primary regulator valve PV to the first oil pressure P1 according to the signal pressure.

The secondary regulator valve SV regulates the oil pressure of excess oil that is discharged from the primary regulator valve PV, that is, the oil pressure on the downstream side (the secondary regulator valve SV side) of the primary regulator valve PV, and on the upstream side (the primary regulator valve PV side) of the secondary regulator valve SV, to the predetermined second oil pressure P2, according to the signal pressure supplied from the linear solenoid valve SLT. In this example, the secondary regulator valve SV regulates the amount by which the excess hydraulic oil discharged from the primary regulator valve PV is to be discharged (drained) to the oil pan, based on the balance between the signal pressure supplied from the linear solenoid valve SLT and a feedback pressure of the second oil pressure P2 regulated by the secondary regulator valve SV. That is, when a large amount of excess oil is discharged from the primary regulator valve PV, the secondary regulator valve SV increases the amount of hydraulic oil to be discharged to the oil pan. On the other hand, when a small amount of excess oil is discharged from the primary regulator valve PV, the primary regulator valve PV reduces the amount of hydraulic oil to be discharged to the oil pan. Thus, the secondary regulator valve SV regulates the oil pressure of the hydraulic oil on the upstream side of the secondary regulator valve SV to the second oil pressure P2 according to the signal pressure.

The linear solenoid valve SLT is supplied with the hydraulic oil of the first oil pressure P1 regulated by the first regulator valve PV, and regulates the valve opening degree according to an SLT command that is output from the control unit 6, thereby outputting the hydraulic oil of a signal pressure according to the SLT command. In this example, the signal pressure, which is output from the linear solenoid valve SLT, is basically a value proportional to the SLT command. Thus, both the SLT command and the signal pressure serve as a command to regulate the line pressure in the present invention. The hydraulic oil of the signal pressure that is output from the linear solenoid valve SLT is supplied to the primary regulator valve PV and the secondary regulator valve SV. Thus, in this example, the signal pressure having the same value is supplied to the primary regulator valve PV and the secondary regulator valve SV. Thus, the control unit 6 controls the primary regulator valve PV and the secondary regulator valve SV so as to regulate the oil pressure to the first oil pressure P1 and the second oil pressure P2 according to the SLT command that is output from the control unit 6. The SLT command, which serves as a control signal of the linear solenoid valve SLT, is determined by the control unit 6 based on various types of vehicle information such as a running load and an acceleration opening degree, and is output to the linear solenoid valve SLT.

The hydraulic oil of the first oil pressure P1 regulated by the first regulator valve PV is supplied to the plurality of friction engagement elements C1, B1 of the transmission apparatus 22 via the shift control valve unit VB, and is supplied to a transmission clutch TC and the like. The hydraulic oil of the second oil pressure P2 regulated by the second regulator valve SV is supplied to a lubricant passage of the transmission apparatus 22, the torque converter 21, a lockup control valve CV for controlling the lockup clutch LC, and the like.

The shift control valve unit (the valve unit) VB is an operation control valve for engaging or disengaging each of the plurality of friction engagement elements C1, B1 of the transmission apparatus 22, and is formed by a plurality of control valves and the like respectively corresponding to the friction engagement elements C1, B1. The shift control valve unit VB opens and closes the plurality of control valves according to the control command from the control unit 6, thereby supplying the hydraulic oil of the first oil pressure P1, which has been regulated by the primary regulator valve PV, to a hydraulic chamber of each friction engagement element C1, B1. Thus, the shift control valve unit VB controls engagement or disengagement of the friction engagement elements C1, B1.

The lockup control valve CV is an operation control valve for engaging or disengaging the lockup clutch LC. The lockup control valve CV is supplied with a signal pressure from a lockup control linear solenoid valve SLU. The lockup control valve CV is opened or closed according to the supplied signal pressure, thereby supplying the hydraulic oil of the second oil pressure P2, which has been regulated by the secondary regulator valve SV, to a hydraulic chamber of the lockup clutch LC. Thus, the lockup control valve CV controls engagement or disengagement of the lockup clutch LC.

Functional sections are structured in the control unit 6 by software or hardware or both of them. Of these functional sections, the functional sections that especially relate to the present invention are: the regulator valve control section 61 for sending a command to regulate the line pressure to the regulator valve unit 5; the line pressure obtaining section 62 for obtaining the line pressure of a desired oil passage in the hydraulic circuit for the above automatic transmission; the auxiliary pump start section 63 for controlling starting of the electric pump 4; and the auxiliary pump stop section 64 for controlling stopping of the electric pump 4. When the line pressure at the time of starting the auxiliary pump 4 is higher than the guaranteed withstand pressure of the electric pump 4, the auxiliary pump start section 63 requests the regulator valve control section 61 to output a command to reduce the line pressure. The auxiliary pump start section 63 starts the auxiliary pump 4 in the state where the line pressure is equal to or lower than the guaranteed withstand pressure. The line pressure obtaining section 64 calculates the line pressure based on the command to regulate the line pressure, which is output from the regulator valve control section 61. The auxiliary pump stop section 64 stops the electric pump 4 on the condition that the line pressure is higher than the guaranteed withstand pressure of the electric pump 4.

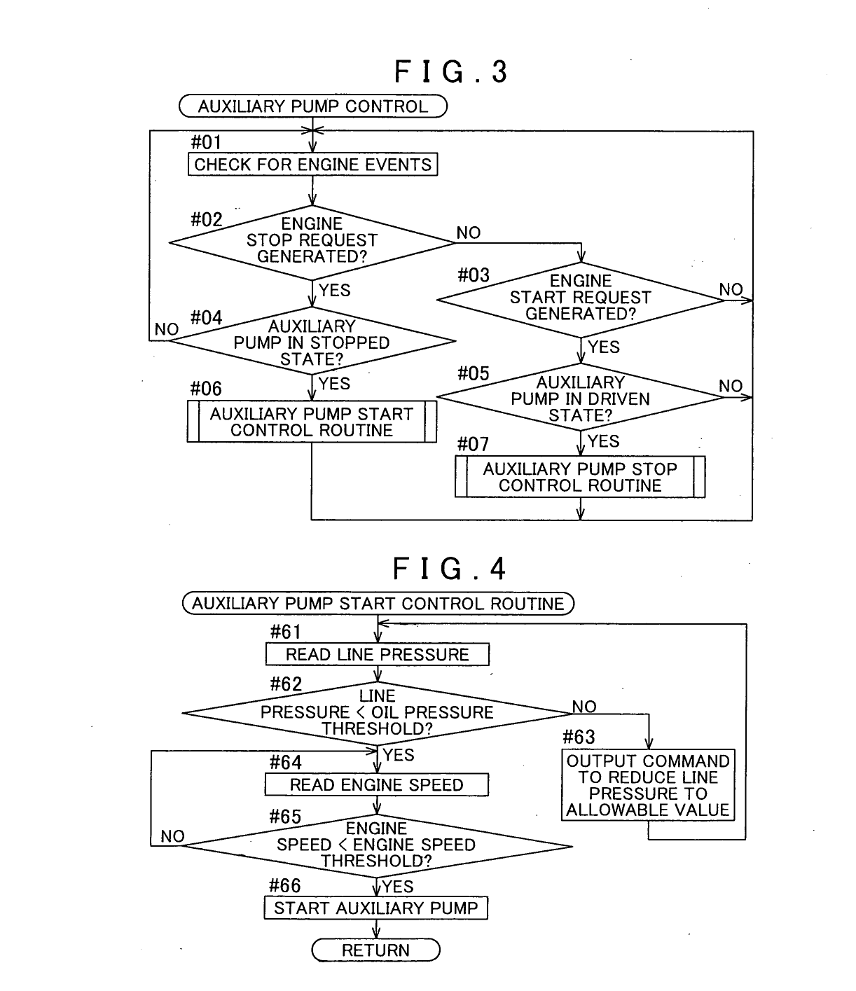

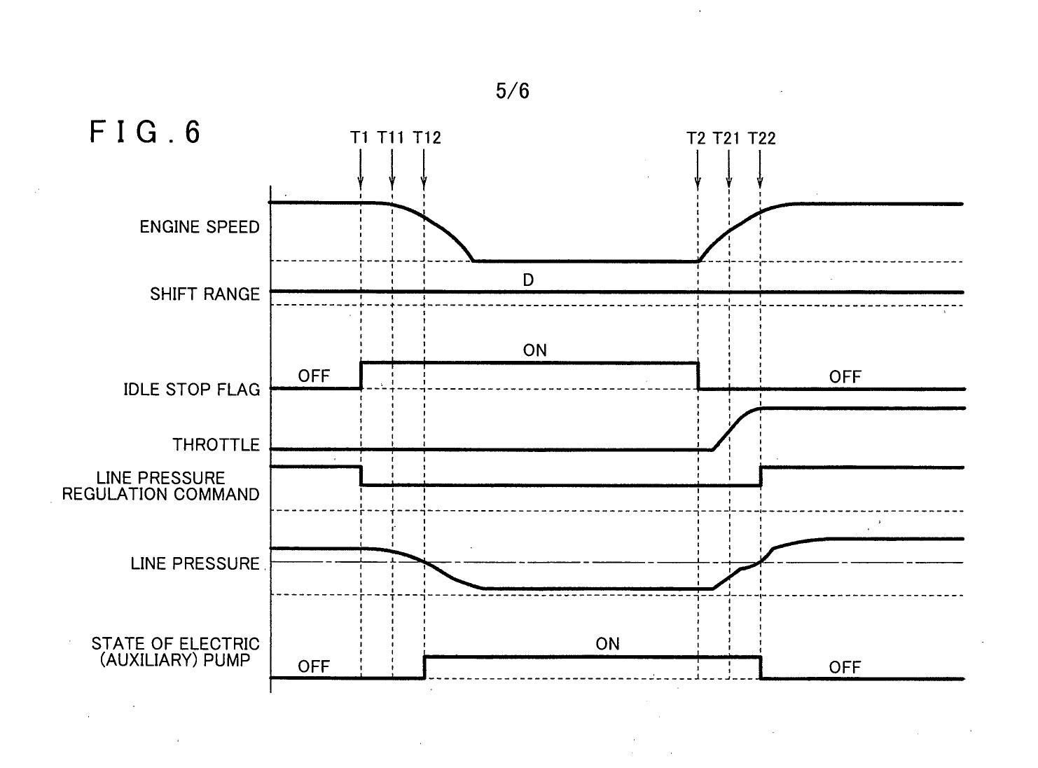

A control flow of the electric pump (the auxiliary pump) 4, which is executed by the control unit 6 structured as described above, will be described below with reference to the flowcharts of FIGS. 3 through 5 and the timing chart of FIG. 6.

The control of the electric pump 4, which is as an auxiliary pump for the mechanical pump 3 that is driven by the engine E, is started upon generation of a request to stop the engine or a request to start the engine. Thus, as shown in FIG. 3, in the auxiliary pump control as a basic control routine for the electric pump, a process of checking for engine events is first performed (#01). As a result, it is determined whether the obtained event is a request to stop the engine or not (#02), and whether the obtained event is a request to start the engine (#03).

For example, if an event to perform the idle stop control occurs, and an idle stop flag is turned ON from OFF (time point T1 in FIG. 6), it is determined that a request to stop the engine has been generated. If the request to stop the engine has been generated (Yes in #02), and the electric pump 4 is in a stopped state (Yes in #04), an auxiliary pump start control routine for appropriately starting the electric pump 4 is executed (#06). If the electric pump 4 is in a driven state in step #04 (No in #04), the electric pump 4 need not be started, and thus, the control flow returns to step #01.

If an event to cancel the idle stop control occurs, and the idle stop flag is turned OFF from ON (time point T2 in FIG. 6), it is determined that a request to start the engine has been generated. If the request to start the engine has been generated (Yes in #03), and the electric pump 4 is in the driven state (Yes in #05), an auxiliary pump stop control routine for appropriately stopping the electric pump 4 is executed (#07). If the electric pump 4 is in the stopped state in step #05 (No in #05), the electric pump 4 need not be stopped, and thus, the control flow returns to step #01.

As shown in FIG. 4, when the auxiliary pump start control routine is executed, the line pressure, which is obtained by the line pressure obtaining section 62 and is considered to act on the electric pump 4, is first read (#61). In the present embodiment, the line pressure obtaining section 62 calculates a desired line pressure based on a command to regulate the line pressure, which is output from the regulator valve control section 61 to the regulator valve unit 5. The line pressure thus read is compared with an oil pressure threshold, which is determined based on an allowable line pressure that is the guaranteed withstand pressure of the electric pump 4 (#62). The guaranteed withstand pressure of the electric pump 4 is a back pressure of the pump main body 40, for which normal rotation of the electric motor 41 of the electric pump 4 is guaranteed. If the line pressure is equal to or higher than the oil pressure threshold (No in #62), the regulator valve control section 6 is requested to output a command to reduce the line pressure, in order to reduce the oil pressure in the oil passage to the allowable line pressure (#63), and the routine returns to step #61. The requested line pressure value included in the command to reduce the line pressure, which is output from the regulator valve control section 6 to the regulator valve unit 5, is a value that is equal to or higher than the minimum transfer torque of the automatic transmission hydraulic clutch, which is requested when the vehicle is started at the line pressure equal to or lower than the guaranteed withstand pressure of the electric motor 41.

When the line pressure becomes lower than the oil pressure threshold (Yes in #62), the engine speed is read (#64), and is compared with an engine speed threshold (#65). This engine speed threshold is determined based on the engine speed at which a line pressure by which the minimum transfer torque capacity of the automatic transmission hydraulic clutch can be sufficiently ensured can be supplied by driving the mechanical pump 3. If the engine speed is equal to or higher than the engine speed threshold (No in #65), the engine speed has not decreased sufficiently, and the oil pressure, generated by the mechanical pump 3, mainly governs the oil pressure of the hydraulic circuit (time point T11 in FIG. 6). Thus, the routine returns to step #64 to wait for the engine speed to decrease. If the engine speed becomes less than the engine speed threshold (Yes in #65), the electric pump 4 is started at this timing (time point T12 in FIG. 6). That is, in the auxiliary pump start control routine in the present embodiment, the electric pump 4 is not started until both a condition to start the auxiliary pump, which is based on the comparison between the line pressure and the oil pressure threshold, and a condition to start the auxiliary pump, which is based on the comparison between the engine speed and the engine speed threshold, are satisfied.

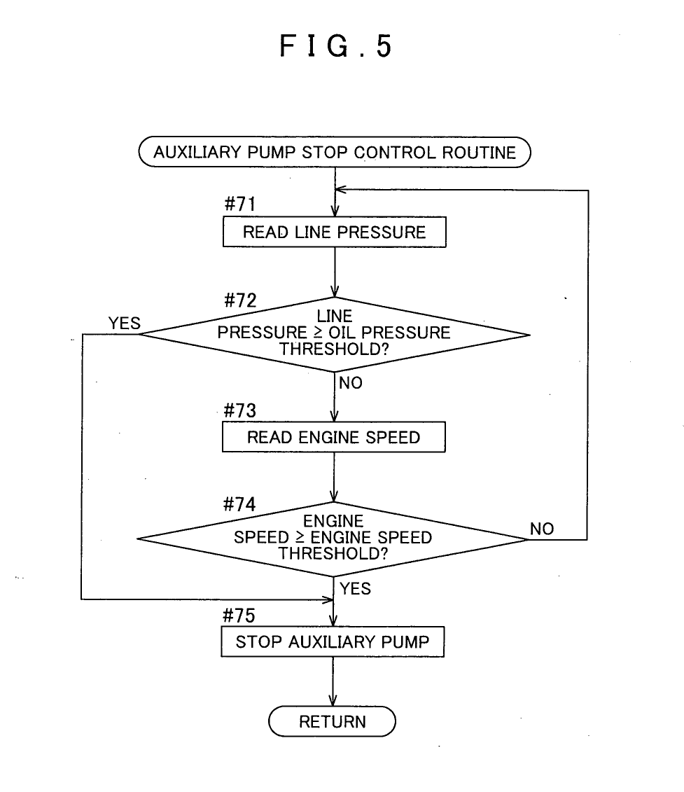

The auxiliary pump stop control routine is executed when an event to cancel the idle stop control occurs, and the idle stop flag is turned OFF from ON (time point T2 in FIG. 6). As shown in FIG. 5, the line pressure is first read in the auxiliary pump stop control routine (#71). The line pressure thus read is compared with the oil pressure threshold, which is determined based on the allowable line pressure that is the guaranteed withstand pressure of the electric pump 4 (#72). If the line pressure is equal to or higher than the oil pressure threshold as in the state obtained at time point T22 in FIG. 6 (Yes in #72), the electric motor 4 is immediately stopped since the electric motor 41 may be adversely affected (#75).

If the line pressure is lower than the oil pressure threshold as in the state obtained at time point T21 in FIG. 6 (No in #72), the engine speed is further read (#73), and is compared with the engine speed threshold (#74). If the engine speed is lower than the engine speed threshold (No in #74), the engine speed has not increased sufficiently, and it is considered that the oil pressure produced by the mechanical pump 3 does not contribute so much to the line pressure of the oil pressure. Thus, the routine returns to step #71 in order to keep the electric pump 4 in the driven state for a while. If the engine speed becomes equal to or higher than the engine speed threshold (Yes in #74), the electric pump 4 is immediately stopped since the electric motor 41 can be adversely affected (#75). That is, in the auxiliary pump stop control routine of the present embodiment, the electric pump 4 is immediately stopped when either the condition to stop the auxiliary pump, which is based on the comparison between the line pressure and the oil pressure threshold, or the condition to stop the auxiliary pump, which is based on the comparison between the engine speed and the engine speed threshold, is satisfied.

### Other Embodiments

(1) In the above embodiment, the control apparatus for controlling starting and stopping of the auxiliary pump is applied to the automatic transmission including the torque converter. However, this control apparatus may also be applied to an automatic transmission such as a continuously variable transmission (CVT) or a dual clutch transmission (DCT), or a hybrid vehicle automatic transmission including a rotating electrical machine.

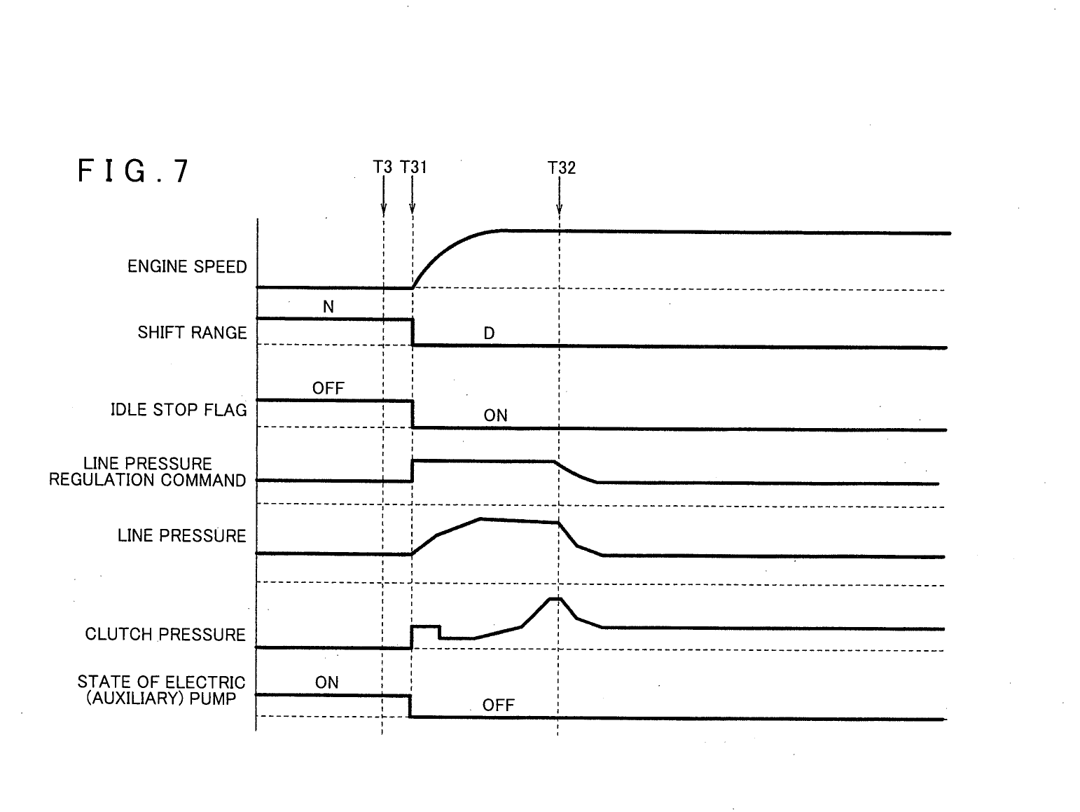

(2) The embodiment suitable for the state where the shift range is kept in “D” range, such as when the vehicle is temporarily stopped at intersections, is described as the control of stopping the auxiliary pump. However, in the case where the process of switching the auxiliary pump from the driven state to the stopped state involves shifting of the shift range from “N” range to “D” range, an event to switch an oil passage in the shift valve occurs before the idle stop event occurs. FIG. 7 is a timing chart illustrating a preferred auxiliary pump stop control in such a condition. After the event to switch the oil passage is generated (time point T3 in FIG. 7), the idle stop flag is turned ON from OFF at the time when the shift range is shifted from “N” to “D” (time point T31 in FIG. 7), whereby a command to increase the line pressure is output. The electric pump is stopped at substantially the same time. Since the engine E is in the driven state at this time, the line pressure becomes high enough for clutch engagement of the frictional engagement element C1, by driving the mechanical pump 3. A command to reduce the line pressure is output when the clutch engagement of the frictional engagement element C1 is established (time point T32 in FIG. 7).

(3) Although a sensorless brushless DC motor is preferable as the electric motor of the auxiliary pump, other types of motors may be used.

The present invention may be preferably used for control apparatuses for controlling supply of an oil pressure to an automatic transmission by using a main pump driven by a vehicle engine, and an auxiliary pump driven by an electric motor.

What is claimed is:

1. A control apparatus for an automatic transmission, comprising:
a main pump that is rotation driven by an engine and supplies hydraulic oil via an oil passage of a vehicle automatic transmission;
an auxiliary pump that is rotation driven by an electric motor and supplies hydraulic oil to the oil passage to assist the main pump;
a regulator valve that regulates a line pressure of the oil passage to a predetermined value;
a regulator valve control section that sends a command to regulate the line pressure to the regulator valve;
a line pressure obtaining section that obtains the line pressure of the oil passage; and
an auxiliary pump start section that controls starting of the auxiliary pump, wherein
the auxiliary pump start section requests the regulator valve control section to output a command to reduce the line pressure, when the line pressure at the time of starting the auxiliary pump is higher than a guaranteed withstand pressure of the auxiliary pump, and the auxiliary pump start section starts the auxiliary pump in a state where the line pressure is equal to or lower than the guaranteed withstand pressure.

2. The control apparatus for an automatic transmission according to claim 1, wherein
the line pressure obtaining section calculates the line pressure based on the command to regulate the line pressure.

3. The control apparatus for an automatic transmission according to claim 2, wherein
a condition that an engine speed has become lower than a predetermined value at which the main pump can supply the line pressure capable of ensuring a minimum transfer torque capacity of an automatic transmission hydraulic clutch, is provided as a condition to start the auxiliary pump by the auxiliary pump start section.

4. The control apparatus for an automatic transmission according to claim 1, further comprising:
a line pressure detector that detects the line pressure, wherein
the line pressure obtaining section calculates the line pressure based on a detection value of the line pressure detector.

5. The control apparatus for an automatic transmission according to claim 1, wherein
in response to the request from the auxiliary pump start section to output the command to reduce the line pressure, the regulator valve control section outputs the command to regulate the line pressure to a value that is equal to or higher than the minimum transfer torque of the automatic transmission hydraulic clutch, which is requested when a vehicle is started at the line pressure equal to or lower than the guaranteed withstand pressure of the auxiliary pump.

6. The control apparatus for an automatic transmission according to claim 1, further comprising:
an auxiliary pump stop section that controls stopping of the auxiliary pump, wherein
a condition that the line pressure is higher than the guaranteed withstand pressure of the auxiliary pump is provided as a condition to stop the auxiliary pump by the auxiliary pump stop section.

7. The control apparatus for an automatic transmission according to claim 1, wherein
a condition that the engine speed has reached a predetermined value corresponding to recovery of the line pressure by the main pump is provided as a condition to stop the auxiliary pump by the auxiliary pump stop section.

8. The control apparatus for an automatic transmission according to claim 6, wherein
a condition that the regulator valve control section has output a command to increase the line pressure is provided as a condition to stop the auxiliary pump by the auxiliary pump stop section.

9. The control apparatus for an automatic transmission according to claim 2, wherein
in response to the request from the auxiliary pump start section to output the command to reduce the line pressure, the regulator valve control section outputs the command to regulate the line pressure to a value that is equal to or higher than the minimum transfer torque of the automatic transmission hydraulic clutch, which is requested when a vehicle is started at the line pressure equal to or lower than the guaranteed withstand pressure of the auxiliary pump.

10. The control apparatus for an automatic transmission according to claim 3, wherein
in response to the request from the auxiliary pump start section to output the command to reduce the line pressure, the regulator valve control section outputs the command to regulate the line pressure to a value that is equal to or higher than the minimum transfer torque of the automatic transmission hydraulic clutch, which is requested when a vehicle is started at the line pressure equal to or lower than the guaranteed withstand pressure of the auxiliary pump.

11. The control apparatus for an automatic transmission according to claim 4, wherein
in response to the request from the auxiliary pump start section to output the command to reduce the line pressure, the regulator valve control section outputs the command to regulate the line pressure to a value that is equal to or higher than the minimum transfer torque of the automatic transmission hydraulic clutch, which is requested when a vehicle is started at the line pressure equal to or lower than the guaranteed withstand pressure of the auxiliary pump.

12. The control apparatus for an automatic transmission according to claim 10, further comprising:
an auxiliary pump stop section that controls stopping of the auxiliary pump, wherein
a condition that the line pressure is higher than the guaranteed withstand pressure of the auxiliary pump is provided as a condition to stop the auxiliary pump by the auxiliary pump stop section.

13. The control apparatus for an automatic transmission according to claim 10, wherein
a condition that the engine speed has reached a predetermined value corresponding to recovery of the line pressure by the main pump is provided as a condition to stop the auxiliary pump by the auxiliary pump stop section.

14. The control apparatus for an automatic transmission according to claim 12, wherein
a condition that the engine speed has reached a predetermined value corresponding to recovery of the line pressure by the main pump is provided as a condition to stop the auxiliary pump by the auxiliary pump stop section.

15. The control apparatus for an automatic transmission according to claim 12, wherein
a condition that the regulator valve control section has output a command to increase the line pressure is provided as a condition to stop the auxiliary pump by the auxiliary pump stop section.

16. The control apparatus for an automatic transmission according to claim 14, wherein
a condition that the regulator valve control section has output a command to increase the line pressure is provided as a condition to stop the auxiliary pump by the auxiliary pump stop section.

17. The control apparatus for an automatic transmission according to claim 9, further comprising:
an auxiliary pump stop section that controls stopping of the auxiliary pump, wherein
a condition that the line pressure is higher than the guaranteed withstand pressure of the auxiliary pump is provided as a condition to stop the auxiliary pump by the auxiliary pump stop section.

18. The control apparatus for an automatic transmission according to claim 9, wherein
a condition that the engine speed has reached a predetermined value corresponding to recovery of the line pressure by the main pump is provided as a condition to stop the auxiliary pump by the auxiliary pump stop section.

19. The control apparatus for an automatic transmission according to claim 17, wherein
a condition that the engine speed has reached a predetermined value corresponding to recovery of the line pressure by the main pump is provided as a condition to stop the auxiliary pump by the auxiliary pump stop section.

20. The control apparatus for an automatic transmission according to claim 17, wherein
a condition that the regulator valve control section has output a command to increase the line pressure is provided as a condition to stop the auxiliary pump by the auxiliary pump stop section.
